(19) United States
(12) Patent Application Publication
(10) Pub. No.: US 2011/0151940 A1
(43) Pub. Date: Jun. 23, 2011

(54) ALTERNATIVE RINGTONES FOR MOBILE TELEPHONES

(76) Inventor: STUART DANIEL FROHLICH, Ramat Bet Shemesh (IL)

(21) Appl. No.: 12/974,036

(22) Filed: Dec. 21, 2010

Related U.S. Application Data
(60) Provisional application No. 61/289,454, filed on Dec. 23, 2009.

(51) Int. Cl. H04W 88/02

(52) U.S. Cl. 455/567

(57) ABSTRACT

A method, implementable on a mobile device, includes activating at least two of the output devices of the mobile device in response to a call-related activity, where the output devices include an audio/video device and at least one non-audio/video device, and stopping the activating when the call-related activity ends.

### CROSS-REFERENCE TO RELATED APPLICATIONS

This application claims priority benefit from U.S. Provisional Patent Application No. 61/289,454, filed Dec. 23, 2009, which is incorporated herein by reference in its entirety.

### FIELD OF THE INVENTION

The present invention relates to cellular telephones generally and to ringtones for cellular telephones in particular.

### BACKGROUND OF THE INVENTION

Cellular telephones are very common. When an incoming call arrives at a cellular telephone, the user is typically notified by the playing of a ringtone—a distinctive sound that indicates that a call has arrived. There are also ringback tones, which are the tones heard when dialing another user.

Some people prefer not to hear a ringtone, particularly when they are in the company of others, such as in a meeting. Cellular telephones typically come with a variety of alternatives, such as a silent mode or a vibrating mode.

US Patent Publication 2005/0258938 to Moulson and U.S. Pat. No. 7,088,816 to Donnelly discuss different types of “alert signals” (i.e. signals which announce a pending call)

### SUMMARY OF THE INVENTION

There is provided, in accordance with a preferred embodiment of the present invention, a method, implementable on a mobile device, which includes activating at least two of the output devices of the mobile device in response to a call-related activity, the output devices including an audio/video device and at least one non-audio/video device, and stopping the activating when the call-related activity ends.

Additionally, in accordance with a preferred embodiment of the present invention, the activating includes receiving activation scripts for a plurality of call-related activities and activating the at least two output devices according to the activation script corresponding to the call-related activity.

Moreover, in accordance with a preferred embodiment of the present invention, the at least one non-audio/video device is at least one pulsing output device. For example, the pulsing output device might be at least one of the light sources of the mobile device. This might be an LED indicator light with multiple colored lights, a camera flash, a backlight of a keyboard or a backlight of a screen.

Alternatively, the pulsing output device might be a vibrator. In this embodiment, the activation script activates the vibrator according to a vibration pattern.

Moreover, in accordance with a preferred embodiment of the present invention, the activating includes causing the mobile device to thump, beat and flash at generally the same time.

Further, in accordance with a preferred embodiment of the present invention, the method includes activating the at least one pulsing output device to a beat generated by the audio/video device.This might include determining the beat, which might be determined by filtering an audio signal of an audio/video ringtone.

Still further, in accordance with a preferred embodiment of the present invention, the activating according to a beat includes aligning activation of the at least one pulsing output device with the audio signal.

There is also provided, in accordance with a preferred embodiment of the present invention, a mobile device including a plurality of output devices including an audio/video device and at least one non-audio/video device and a device activator to activate at least two of the output devices of the mobile device in response to a call-related activity and to stop the activation when the call-related activity ends.

Moreover, in accordance with a preferred embodiment of the present invention, the device activator includes a receiver to receive activation scripts for a plurality of call-related activities and a script player to activate the at least two output devices according to the activation script corresponding to the call-related activity. When the at least one pulsing output device is a vibrator, the script player includes a unit to activate the vibrator according to a vibration pattern.

Further, in accordance with a preferred embodiment of the present invention, the device also includes a beat activator to activate the at least one pulsing output device to a beat played by the audio/video device.

Finally, in accordance with a preferred embodiment of the present invention, the beat activator includes a beat determiner to determine the beat. For example, the beat determiner includes a filter to filter an audio signal of an audio/video ringtone.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an exemplary mobile device;

FIG. 2 is a timing diagram for an exemplary combination ringtone providing a combined audio, video, vibration and flashing ringtone;

FIGS. 3A and 3B are graphs showing exemplary combined activity of a speaker and a vibrator and/or flash element of a cellphone; and

FIGS. 4A, 4B and 4C are schematic illustrations of three embodiments of a mobile deivce, constructed and operative in accordance with a preferred embodiment of the present invention, which responds to the beat of a ringtone.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that mobile telephones and/or other mobile devices, such as PDAs (personal digital assistants), have a plurality of output capabilities which may be utilized for call-related activities.

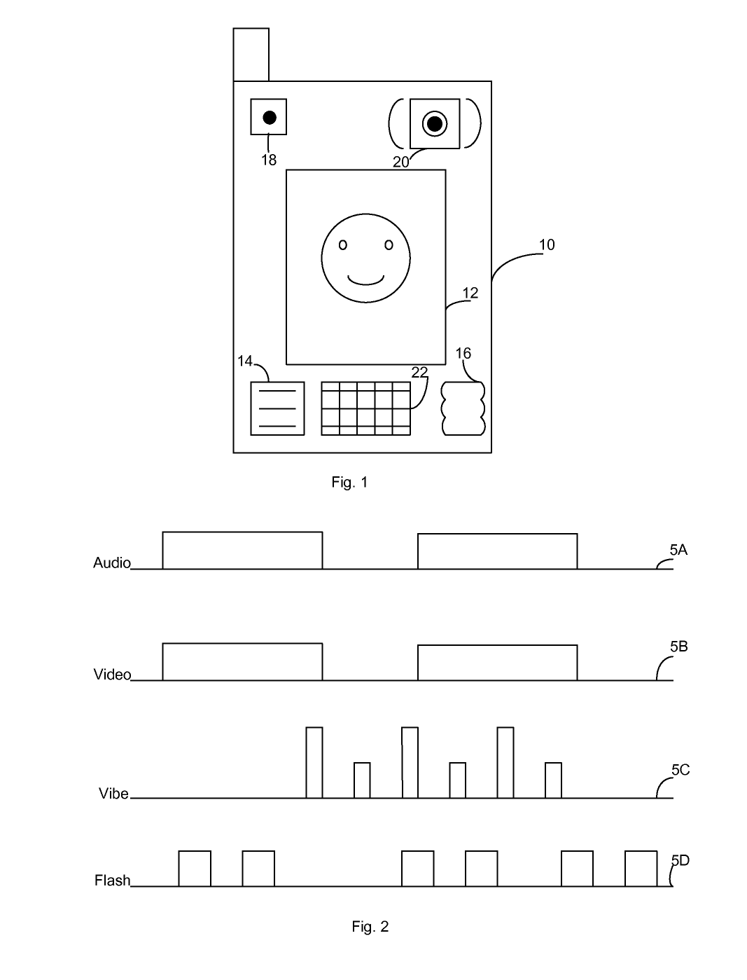

Reference is now made to FIG. 1, which illustrates an exemplary mobile device 10. It typically comprises a screen 12 for displaying video, a speaker 14 for providing an audio output, and a vibrator 16 for providing a vibration alert. These are the standard output elements of device 10. However, Applicants have realized that there are other output elements and that they may be utilized for alternative ringtones. For example, mobile device 10 typically also has an LED indicator light 18, typically used to indicate the presence of messages. Mobile device 10 also has a camera flash 20, generally activated when taking a picture. Finally, mobile device 10 has backlighting, on its keyboard 22 and on its screen 12.

Applicants have realized that, since all of these devices are controllable by various elements of mobile device 10, they may be controlled also for ringtone operation.

Thus, a ringtone may use speaker 14 for audio, screen 12 for video, vibrator 16 for vibrations and LED indicator light 18 and/or camera flash 20 and/or the backlights of either keyboard 22 or screen 12 for flashing lights. If all output elements are active at the same time, this may cause the mobile device to thump, beat and flash all at the same time.

Alternatively, the devices can operate independently. For example, there might be a vibration ringtone or alert, which vibrates a different beat pattern, depending on the caller or callee, or, alternatively, depending on the status of the call (ringing, call waiting, busy, etc).

Each vibration ringtone may have a different vibration pattern. One pattern might be a simple vibration every M seconds. Another might involve varying short and long vibrations. Another might involve different intensities of vibrations. The variations are endless.

For example, a user may be in a meeting and may have set his phone to vibrate mode. In accordance with a preferred embodiment of the present invention, the user will then receive the vibration ringtone associated with a caller rather than the caller's associated audio or video ringtone. Thus, if the user has set vibration ringtones for his/her various friends and/or family, he might be able to identify that the current phone call, vibrating in his pocket, is from his Mother, even though he cannot see the phone. The user can then choose to answer or not during the meeting.

The following is markup language for an exemplary “vibe” which vibrates for 100 ms at intensity of 1, is silent for 100 ms, then vibrates for 200 ms ascending in intensity from 1 to 10 and then vibrates for 200 ms descending in intensity from 10 to 1. This vibe may repeat until the phone is answered.

```
<vibe>
    <vibrate>
        <type=“normal” duration=100 intensity=1>
    <vibrate/>
    <silence duration=100/>
    <vibrate>
        <type=“ascending” duration=200 intensity_min=1
        intensity_max=10>
    <vibrate/>
    <vibrate>
        <type=“descending” duration=200 intensity_min=1
        intensity_max=10>
    <vibrate/>
<vibe/>
```

Ringtones are generally registered in mobile devices as being associated with items in contact lists. In accordance with a preferred embodiment of the present invention, each vibration ringtone may be listed in the contact information as an additional type of ringtone. Thus, an exemplary contact may list the following:
Name: John Doe
Tel: (501) 555-1212
Ringtone: music.3GP
Vibe: JohnVibe.vbp

where “JohnVibe.vbp” may be a file having the script similar in style to that listed above.

Ringtones may be manually set or may change as a function of some other event. For example, changing to a Bluetooth earpiece may change the “profile” of the phone, which typically changes the type of ringtone as well. The ringtones discussed herein may also change as a function of changes in profiles and/or other events, such as GPS location.

As mentioned hereinabove, a “flash ringtone” may be generated using LED indicator light 18 and/or camera flash 20 and/or the backlights of either keyboard 22 or screen 12. The backlight of keyboard 22 may be only a single color, but LED indicator light 18 typically has multiple lights, such as red, green and blue, and the backlight of screen 12 may also be changed. Some devices 10 may also comprise a pointing device such as, for example, a mouse, trackpoint or trackball. It will be appreciated that such devices 10 may also have various lighting options for such pointing devices, each of which may be used to generate/play a flash ringtone. It will further be appreciated that the present invention may include any lighting source that may be found on a device 10.

A flash ringtone may define different light patterns of a single or of multiple output devices. Moreover, different light patterns may be assigned for different callers or callees, or, alternatively, as a function of the status of the call (ringing, call waiting, busy, etc).

Applicants have realized that vibrations and flashing ringtones are “pulse” ringtones (i.e. a collection of pulses of varying lengths and degrees of intensity). Thus, a single pulse markup language may be defined, to describe one or both of the pulse type ringtones.

The following is an example of a “pulse ringtone” activating both vibrator 16 and LED indicator light 18:

```
    <pulse_call_alert>
        <pulse>
          <output=“vibrate” type=“normal” duration=100 intensity=1>
          <output=“front_led” color=“red” type=“normal” duration=100
intensity=1>
        <pulse/>
        <pause duration=100/>
        <pulse>
          <output=“vibrate” type=“ascending” duration=200  intensity_min=1
intensity_max=10>
          <output=“front_led” color=“blue” type=“ascending” duration=200
intensity_min=1 intensity_max=10>
        <pulse/>
        <pulse>
          <output=“vibrate” type=“descending” duration=200  intensity_min=1
intensity_max=10>
          <output=“front_led” color=“blue” type=“descending” duration=200
intensity_min=1 intensity_max=10>
        <pulse/>
    <pulse_call_alert/>
```

An exemplary contact may also list the pulse ringtone, as follows:
Name: John Doe
Tel: (501) 555-1212
Ringtone: music.3GP
Pulse: JohnPulse.ppp

where “JohnPulse.ppp” may be a file having the script similar in style to that listed above.

It will be appreciated that the pulse ringtone may activate one or more of the pulsing actuators, such as vibrator 16, LED indicator light 18 and/or camera flash 20 and/or the backlights of either keyboard 22 or screen 12.

As mentioned hereinabove, the ringtone may be of a single output device or of a combination of some or all of a mobile device's output capabilities. This is shown in FIG. 2, to which reference is now made. Thus, in FIG. 2, a ringtone may be a combination of an audio, video, vibration and flash ringtone, using speaker 14 (for audio), screen 12 (for video), vibrator 16 (for the vibe) and one or more of keyboard backlight 22, camera flash 20, LED indicator light 18 and screen backlight 12 (for the flash). This may cause the mobile device to thump, beat and flash all at the same time.

FIG. 2 shows four time lines 5, where time line 5A is for the audio signal, time line 5B is for the video signal, time line 5C is for the vibe and time line 5D is for the flash. As can be seen, each signal is active at different times, where the audio and video signals are active, together, for a significant amount of time, while the vibes are relatively infrequent short spikes and the flashes are also infrequent, but are active for longer than the vibes.

The instructions for such a combined ringtone may be written in a single script or may be written as separate scripts, to be run at the same time. A “Call Alert Markup Language” (CAML) may describe a combined ringtone and may provide instructions such that different devices operate at different times in the ringtone.

It will be appreciated that the mobile device may run the ringtone scripts for each of the output devices of the mobile device, alone or in combination, for any appropriate call-related activity and may stop the scripts when the call-related activity ends. It will also be appreciated that the ringtone scripts may be played when requested, irrespective of call-related activity.

Prior patent application U.S. Ser. No. 11/544,938, now U.S. Pat. No. 7,761,816, assigned to the common assignee of the present application and incorporated herein in its entirety by reference, defines a variation of a video ringtone in which the video clip is chosen by the calling party, to be displayed on the called handset. U.S. Pat. No. 7,761,816 also discloses a community server, an Internet-based server that allows users to choose video clips to be distributed to their friends (or “buddies”). An add-on client application to be installed on the communication devices of members of a video ringtone sharing community is also disclosed. This application may be configured to receive a shared video clip from the community server and associate it with a particular buddy for playing when the buddy calls.

It will further be appreciated that the pulse ringtones of the present invention, vibe, flash and/or combination, may be distributed among buddies using a system similar to that described in U.S. Pat. No. 7,761,816 or using any other system which may provide ringtones to other people.

In accordance with a further preferred embodiment of the present invention, the cellphone may be set to vibrate or flash in accordance with the beat of a current ringtone. As the ringtone changes, the vibration or flashing may change as well. This may hold for both audio and video ringtones.

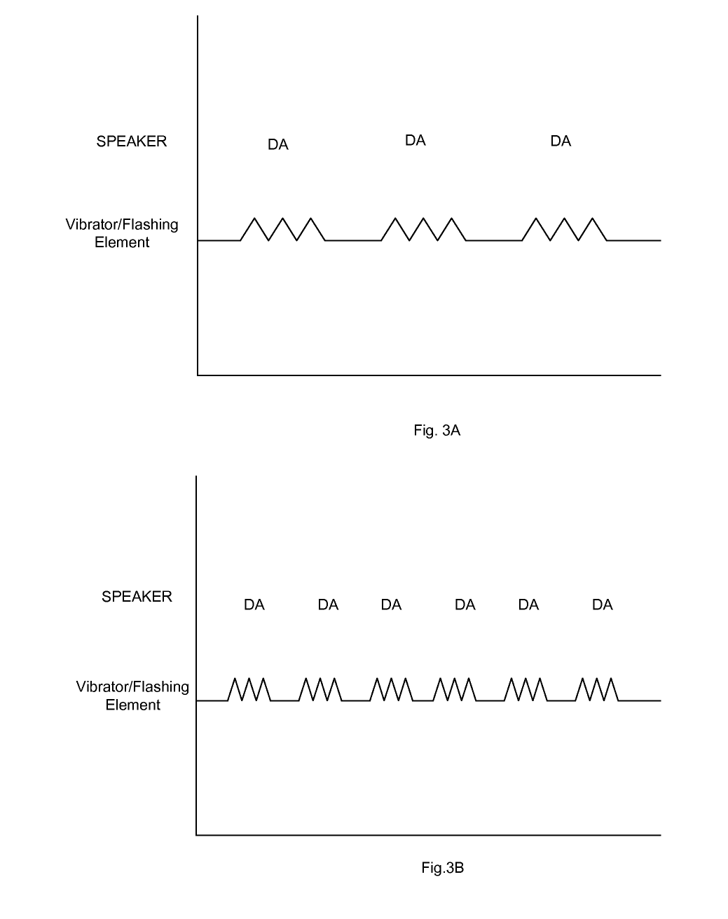

FIGS. 3A and 3B, to which reference is now briefly made, show exemplary activity of a speaker and a vibrator and/or flash element of a cellphone, operative in accordance with a preferred embodiment of the present invention. In both figures, the melody is a very simple song, with the word “Da” repeated on the beat. In FIG. 3A, the beat is slow while in FIG. 3B, the beat is fast. As can be seen, the vibrator vibrates in time with the music, vibrating at each repetition of the word “Da”, slowly in FIG. 3A and twice as fast in FIG. 3B.

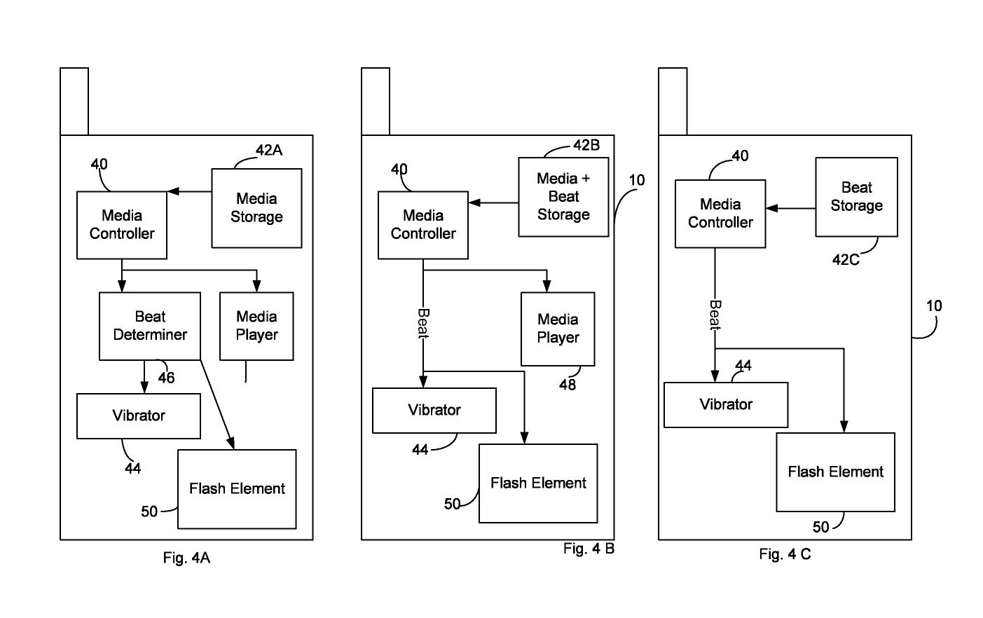

FIGS. 4A-4C, to which reference is now made, show multiple embodiments of the present invention. In each, the cellphone, labeled 10A, 10B or 10C, respectively, comprises a media controller 40, a storage device 42, a vibrator 44 and a flashing element 50. In FIG. 3A, storage device 42 is a media storage device 42A, storing the audio and/or video ringtones. Media controller 40 provides a selected ringtone from media storage 42A to both a media player 48 and a beat determiner 46.

Beat determiner 46 analyzes the ringtone file to determine the beat and provides the beat information to vibrator 44 and/or flashing element 50, such that vibrator 44 may vibrate to the beat and/or flashing element 50 may flash to the beat. In one embodiment, beat determiner 46 may provide only the main beats (such as the first beat in each measure) or it may provide any of the beats, as desired.

Media player 48 may play the ringtone. To ensure that vibrator 44 vibrates to the beat and/or flashing element 50 flashes to the beat, media controller 40 may start media player 48 only once beat determiner 46 has finished analyzing the file, or after a predefined delay.

Cellphone 10B of FIG. 4B solves the problem of aligning the beat operation with the ringtone playing. In FIG. 4B, storage 42 is a media and beat storage unit 42B, storing the beat information alongside the ringtone. Thus, in this embodiment, media controller 40 may provide the ringtone to media player 48 and the beat information to vibrator 44 and/or flashing element 50 in a generally synchronized manner such that they play together. It will be appreciated that the beat information stored in unit 42B may be determined, offline, with an external beat determiner.

Cellphone 10C of FIG. 4C just gives an interesting beat for vibration or for flashing. Thus, storage unit 42 is a beat storage unit 42C and media controller 40 provides the beat information to vibrator 44 and/or flashing element 50 on the occasion of a call.

Beat determiner 46 may be any suitable beat determiner which may provide the beat, for example, by isolating the lower frequencies or a desired set of frequencies, in the audio signal of the audio or audio/video ringtone.

An exemplary beat determiner 46 may be a filter or set of filters. For example, it may be a band pass or a low pass filter (which may be implemented as a finite or infinite impulse response (FIR or IIR) filter.

An alternative beat determiner 46 may be implemented as a discrete Fourier transform (DFT) or a fast Fourier transform (FFT).

A further alternative beat determiner 46 may be a non-linear algorithm which may operate by feature extraction, such as a median filter.

It will also be appreciated that the ringtone and beat information may be downloaded into storage unit 42 in any suitable way. The cellphone user may download it or it may be downloaded as part of a ringtone or persona sharing system.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method, implementable on a mobile device, the method comprising:
having output devices on said mobile device, said output devices comprising an audio/video device and at least one non-audio/video device;
activating at least two of said output devices of said mobile device in response to a call-related activity; and
stopping said activating when said call-related activity ends.

2. The method according to claim 1 wherein said activating comprises:
receiving activation scripts for a plurality of call-related activities; and
activating said at least two output devices according to said activation script corresponding to said call-related activity.

3. The method according to claim 1 wherein said at least one non-audio/video device is at least one pulsing output device.

4. The method according to claim 3 and wherein said at least one pulsing output device is at least one of the light sources of said mobile device.

5. The method according to claim 4 and wherein said at least one light source is an LED indicator light with multiple colored lights

6. The method according to claim 4 and wherein said at least one light source is one of following light sources: a camera flash, a backlight of a keyboard and a backlight of a screen.

7. The method according to claim 2 and wherein said at least one pulsing output device is a vibrator and wherein said activation script activates said vibrator according to a vibration pattern.

8. The method according to claim 1 wherein said activating includes causing said mobile device to thump, beat and flash at generally the same time.

9. The method according to claim 3 and also comprising activating said at least one pulsing output device to a beat generated by said audio/video device.

10. The method according to claim 9 and wherein said activating according to a beat comprises determining said beat.

11. The method according to claim 9 and wherein said determining comprises filtering an audio signal of an audio/video ringtone.

12. The method according to claim 11 and wherein said activating according to a beat comprises aligning activation of said at least one pulsing output device with said audio signal.

13. A mobile device comprising:
a plurality of output devices comprising an audio/video device and at least one non-audio/video device; and
a device activator to activate at least two of said output devices of said mobile device in response to a call-related activity and to stop the activation when said call-related activity ends.

14. The device according to claim 13 wherein said device activator comprises:
a receiver to receive activation scripts for a plurality of call-related activities; and
a script player to activate said at least two output devices according to said activation script corresponding to said call-related activity.

15. The device according to claim 13 wherein said at least one non-audio/video device is at least one pulsing output device.

16. The device according to claim 15 and wherein said at least one pulsing output device is at least one of the light sources of said mobile device.

17. The device according to claim 16 and wherein said at least one light source is an LED indicator light with multiple colored lights

18. The device according to claim 16 and wherein said at least one light source is one of following light sources: a camera flash, a backlight of a keyboard and a backlight of a screen.

19. The device according to claim 14 and wherein said at least one pulsing output device is a vibrator and wherein said script player comprises a unit to activate said vibrator according to a vibration pattern.

20. The device according to claim 15 and also comprising a beat activator to activate said at least one pulsing output device to a beat played by said audio/video device.

21. The device according to claim 20 and wherein said beat activator comprises a beat determiner to determine said beat.

22. The device according to claim 20 and wherein said beat determiner comprises a filter to filter an audio signal of an audio/video ringtone.
